(19) United States
(12) Patent Application Publication
(10) Pub. No.: US 2015/0193683 A1
(43) Pub. Date: Jul. 9, 2015

(54) ASSISTING AN EXPERT TO ANSWER PREEXISTING QUESTIONS IN A TIME EFFICIENT MANNER

(71) Applicant: Lenovo Enterprise Solutions (Singapore) PTE. LTD., Singapore (SG)

(72) Inventors: Andrew R. Freed, Cary, NC (US); Dale J. Heeks, Cary, NC (US); Joshua D. Lowry, Morrisville, NC (US); Dorian B. Miller, Cary, NC (US); Dana L. Price, Cary, NC (US)

(21) Appl. No.: 14/148,965

(22) Filed: Jan. 7, 2014

(51) Int. Cl. G06N 5/02

(52) U.S. Cl. CPC G06N 5/02

(57) ABSTRACT

A method, system and computer program product for assisting an expert to answer preexisting questions in a time efficient manner. The expert's data entry in a data entry system is detected by a unit, referred to herein as the “analyzer.” The analyzer searches a database or social media websites to identify questions that could possibly be answered using the expert's inputted data. Such questions may be identified using tag searching, keyword searching and/or natural language processing. The analyzer performs analytical analysis on these identified questions to assign a relevance factor to assess how relevant is the expert's inputted data in answering the question. For those questions whose relevance factor exceeds a threshold, those questions are presented to the expert in a list. In this manner, the expert does not have to spend time searching social media websites for applicable questions to answer.

### TECHNICAL FIELD

The present invention relates generally to seeking answers to questions, and more particularly to assisting an expert to answer preexisting questions, such as questions posted in various forums, in a time efficient manner without having the expert search for these questions to answer.

### BACKGROUND

Oftentimes, people post questions on social media websites, such as forums and newsgroups. For example, users may have questions regarding which operating systems are supported by a particular relational database management system. There may be experts with the expertise to answer these questions but not the time to answer these questions, including not having the time to search for these questions to answer, such as searching for these questions posted on social media websites. For example, a relational database management system expert may update the official operating system support records for that database product. However, the expert does not have the time to search for questions on this topic, such as searching for questions on this topic on social media websites. As a result, these questions may not be answered leaving the users that posted these questions frustrated that no one could assist them.

### BRIEF SUMMARY

In one embodiment of the present invention, a method for assisting an expert to answer preexisting questions in a time efficient manner comprises detecting a data entry in a data entry system. The method further comprises identifying added or modified data in the data entry system in response to detecting the data entry in the data entry system. Additionally, the method comprises searching, by a processor, a database or social media websites to identify questions that could possibly be answered using the identified added or modified data. Furthermore, the method comprises assigning a relevance factor to each of the questions that could possibly be answered using the identified added or modified data. In addition, the method comprises identifying questions whose relevance factor exceeds a threshold. The method additionally comprises presenting a list of the identified questions whose relevance factor exceeds the threshold to the expert. The method further comprises receiving a selection of one or more questions presented in the list of the identified questions. In addition, the method comprises performing an action to provide an answer to the selected one or more questions using the identified added or modified data.

Other forms of the embodiment of the method described above are in a system and in a computer program product.

The foregoing has outlined rather generally the features and technical advantages of one or more embodiments of the present invention in order that the detailed description of the present invention that follows may be better understood. Additional features and advantages of the present invention will be described hereinafter which may form the subject of the claims of the present invention.

### BRIEF DESCRIPTION OF THE SEVERAL VIEWS OF THE DRAWINGS

A better understanding of the present invention can be obtained when the following detailed description is considered in conjunction with the following drawings, in which:

FIG. 1 illustrates a social network system configured in accordance with an embodiment of the present invention;

FIG. 2 illustrates a hardware configuration of the analyzer configured in accordance with an embodiment of the present invention;

FIG. 3 is a flowchart of a method for populating a database with questions obtained from social media websites in accordance with an embodiment of the present invention;

FIG. 4 is a flowchart of a method for assisting an expert to answer preexisting questions in a time efficient manner using the questions populated in the database; and

FIG. 5 is a flowchart of an alternative method for assisting an expert to answer preexisting questions in a time efficient manner by seeking out questions in social media websites based on the input provided by the expert into the data entry system in accordance with an embodiment of the present invention.

### DETAILED DESCRIPTION

The present invention comprises a method, system and computer program product for assisting an expert to answer preexisting questions in a time efficient manner. In one embodiment of the present invention, the expert's data entry in a data entry system is detected by a unit, referred to herein as the “analyzer,” where the added or modified data that was inputted by the expert in the data entry system is identified in response to the expert saving or committing the changes. The analyzer searches a database or social media websites (e.g., forums) to identify questions that could possibly be answered using the identified added or modified data. Questions that could possibly be answered by the expert's data entry may be identified using tag searching, keyword searching and/or natural language processing. The analyzer performs analytical analysis (e.g., statistical and/or logical techniques) on these identified questions to assign a relevance factor to assess how relevant is the expert's data entry in answering the question. For those questions whose relevance factor exceeds a threshold, those questions are presented to the expert in a list. In this manner, the expert does not have to spend time searching social media websites for applicable questions to answer. Instead, the expert may simply select the questions to answer by selecting those applicable questions from the list. In response to the expert selecting question(s) to answer, the analyzer performs an action (e.g., post, e-mail, annotate, mark) to provide an answer to the selected question(s) based on the identified added or modified data. By having the analyzer perform such actions to provide an answer to the expert's selected question(s), the selected question(s) are answered in a time efficient manner without the expert spending a significant time in answering these questions.

In the following description, numerous specific details are set forth to provide a thorough understanding of the present invention. However, it will be apparent to those skilled in the art that the present invention may be practiced without such specific details. In other instances, well-known circuits have been shown in block diagram form in order not to obscure the present invention in unnecessary detail. For the most part, details considering timing considerations and the like have been omitted inasmuch as such details are not necessary to obtain a complete understanding of the present invention and are within the skills of persons of ordinary skill in the relevant art.

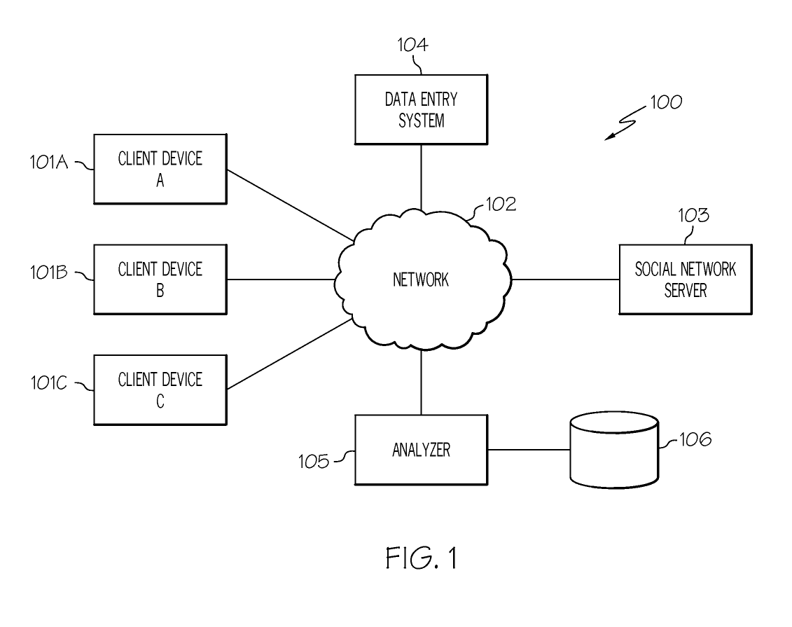

Referring now to the Figures in detail, FIG. 1 illustrates a social network system 100 configured in accordance with an embodiment of the present invention. Social network system 100 includes a community of users using client devices 101A-101C (identified as “Client Device A,” “Client Device B,” and “Client Device C,” respectively, in FIG. 1) to be involved in social network system 100. Client devices 101A-101C may collectively or individually be referred to as client devices 101 or client device 101, respectively. Client device 101 may be a portable computing unit, a Personal Digital Assistant (PDA), a smartphone, a laptop computer, a mobile phone, a navigation device, a game console, a desktop computer system, a workstation, an Internet appliance and the like.

Client devices 101 may participate in a social network by communicating (by wire or wirelessly) over a network 102, which may be, for example, a local area network, a wide area network, a wireless wide area network, a circuit-switched telephone network, a Global System for Mobile Communications (GSM) network, Wireless Application Protocol (WAP) network, a WiFi network, an IEEE 802.11 standards network, various combinations thereof, etc. Other networks, whose descriptions are omitted here for brevity, may also be used in conjunction with system 100 of FIG. 1 without departing from the scope of the present invention.

System 100 further includes a social network server 103, which be a web server configured to offer a social networking and/or microblogging service, enabling users of client devices 101 to post messages (e.g., text-based messages) on social networks, including blogs, forums, communities, etc. “Messages,” as used herein, include text-based messages that include any one or more of the following: text (e.g., comments, sub-comments and replies), audio, video images, etc. Social network server 103 is connected to network 102 by wire or wirelessly. While FIG. 1 illustrates a single social network server 103, it is noted for clarity that multiple servers may be used to implement the social networking and/or microblogging service.

System 100 further includes a data entry system 104, such as an expert, official or trusted system, where an expert (e.g., user of client device 101A) inputs data into the system that could be used to answer preexisting questions that are posted on social media websites, such as forums. An “expert,” as used herein, refers to a user of client device 101 with the expertise or special skill and knowledge in a particular area. Data entry system 104 is connected to network 102 by wire or wirelessly.

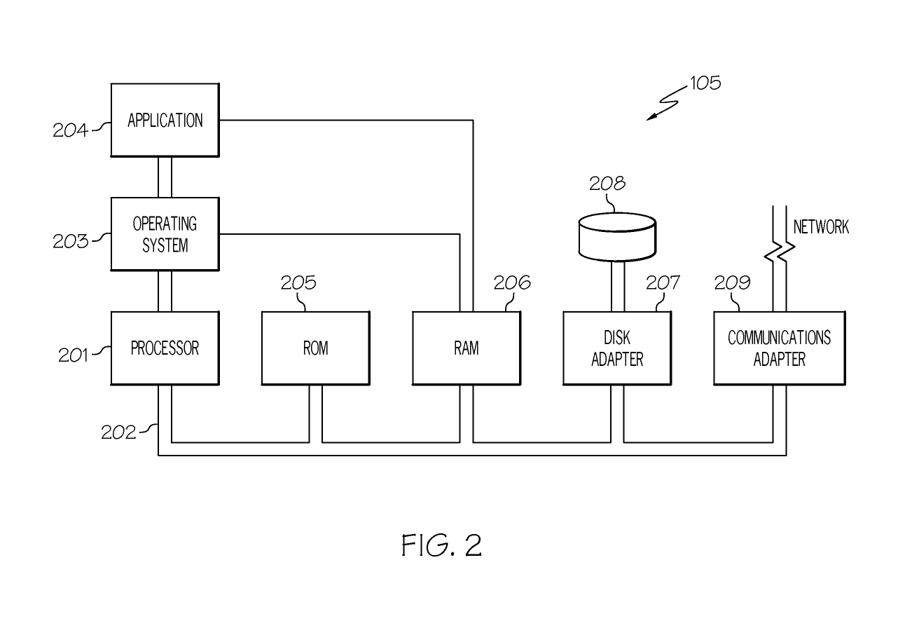

System 100 additionally includes an analyzer 105 connected to network 102 by wire or wirelessly. Analyzer 105 is configured to assist the expert to answer preexisting questions, such as questions posted in various forums, in a time efficient manner without having the expert to search for these questions to answer as discussed in further detail below. A description of the hardware configuration of analyzer 105 is provided below in connection with FIG. 2.

System 100 further includes a database 106 connected to analyzer 105, where database 106 is configured to store questions that could possibly be answered by the expert. In one embodiment, database 106 is populated with questions obtained from social media websites that could possibly be answered by the expert based on the input provided by the expert into data entry system 104. In another embodiment, database 106 is populated with questions in general that are obtained from social media websites without any consideration of the input provided by the expert into data entry system 104.

System 100 is not to be limited in scope to any one particular network architecture. System 100 may include any number of client devices 101, networks 102, social network servers 103, data entry systems 104, analyzers 105 and databases 106. Furthermore, in one embodiment, analyzer 105 may be part of social network server 103. In another embodiment, analyzer 105 may be part of client device 101.

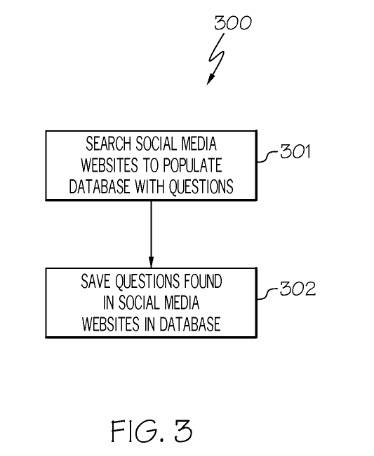

Referring now to FIG. 2, FIG. 2 illustrates a hardware configuration of analyzer 105 (FIG. 1) which is representative of a hardware environment for practicing the present invention. Referring to FIG. 2, analyzer 105 has a processor 201 coupled to various other components by system bus 202. An operating system 203 runs on processor 201 and provides control and coordinates the functions of the various components of FIG. 2. An application 204 in accordance with the principles of the present invention runs in conjunction with operating system 203 and provides calls to operating system 203 where the calls implement the various functions or services to be performed by application 204. Application 204 may include, for example, a program for assisting the expert to answer preexisting questions, such as questions posted in various forums, in a time efficient manner without having the expert to search for these questions to answer as discussed further below in association with FIGS. 3-5.

Referring again to FIG. 2, read-only memory (“ROM”) 205 is coupled to system bus 202 and includes a basic input/output system (“BIOS”) that controls certain basic functions of analyzer 105. Random access memory (“RAM”) 206 and disk adapter 207 are also coupled to system bus 202. It should be noted that software components including operating system 203 and application 204 may be loaded into RAM 206, which may be analyzer's 105 main memory for execution. Disk adapter 207 may be an integrated drive electronics (“IDE”) adapter that communicates with a disk unit 208, e.g., disk drive. It is noted that the program for assisting the expert to answer preexisting questions, such as questions posted in various forums, in a time efficient manner without having the expert to search for these questions to answer, as discussed further below in association with FIGS. 3-5, may reside in disk unit 208 or in application 204.

Analyzer 105 may further include a communications adapter 209 coupled to bus 202. Communications adapter 209 interconnects bus 202 with an outside network (e.g., network 102 of FIG. 1) thereby allowing analyzer 105 to communicate with client devices 101, social network server 103 and data entry system 104.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” ‘module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the function/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

As stated in the Background section, oftentimes, people post questions on social media websites, such as forums and newsgroups. For example, users may have questions regarding which operating systems are supported by a particular relational database management system. There may be experts with the expertise to answer these questions but not the time to answer these questions, including not having the time to search for these questions to answer, such as searching for these questions posted on social media websites. For example, a relational database management system expert may update the official operating system support records for that database product. However, the expert does not have the time to search for questions on this topic, such as searching for questions on this topic on social media websites. As a result, these questions may not be answered leaving the users that posted these questions frustrated that no one could assist them.

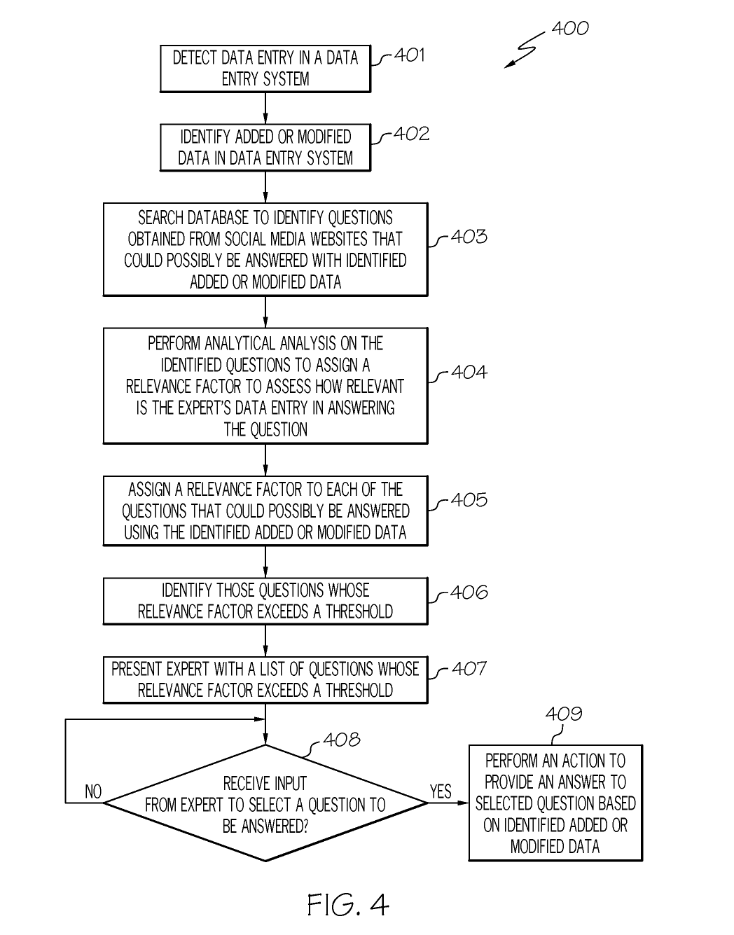

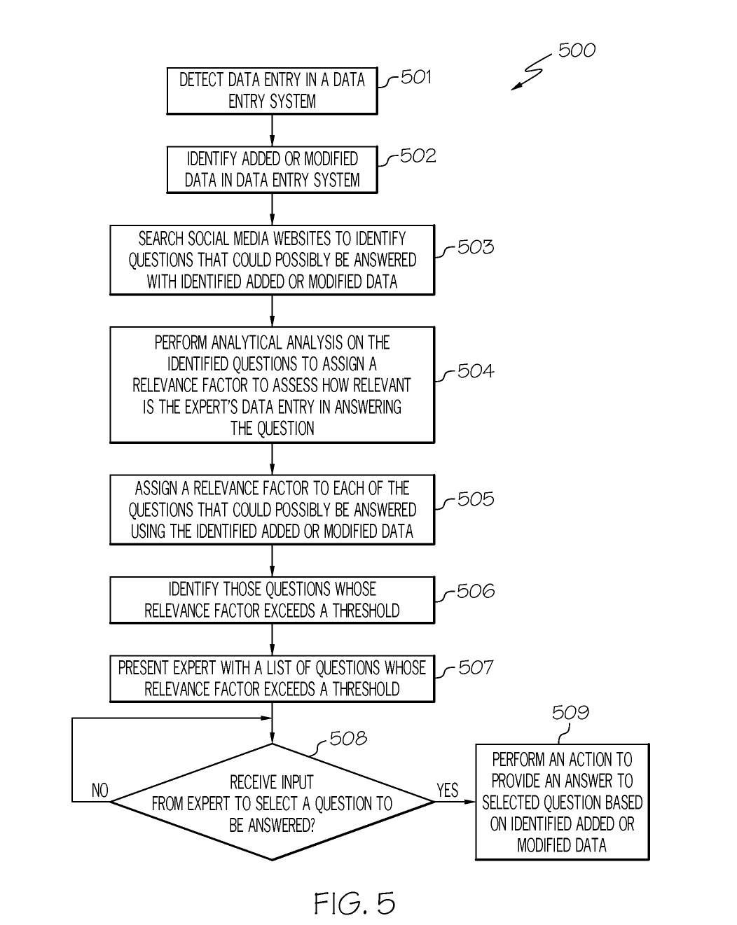

The principles of the present invention provide a means for allowing an expert to answer preexisting questions without having to search for those questions to answer as discussed below in association with FIGS. 3-5. FIG. 3 is a flowchart for populating a database (e.g., database 106 of FIG. 1) with questions obtained from social media websites. FIG. 4 is a flowchart of a method for assisting an expert to answer preexisting questions in a time efficient manner using the questions populated in the database. FIG. 5 is a flowchart of an alternative method for assisting an expert to answer preexisting questions in a time efficient manner by seeking out questions in social media websites based on the input provided by the expert into the data entry system (e.g., data entry system 104 of FIG. 1).

As stated above, FIG. 3 is a flowchart of a method 300 for populating a database (e.g., database 106 of FIG. 1) with questions obtained from social media websites (e.g., forums, blogs, communities) in accordance with an embodiment of the present invention.

Referring to FIG. 3, in conjunction with FIGS. 1-2, in step 301, analyzer 105 searches social media websites (e.g., forums, blogs, communities) to populate database 106 with questions. In one embodiment, analyzer 105 may identify questions using keyword searching, such as identifying questions that end with the use of the question mark sign (e.g., “?”) or identifying questions that begin with particular terms, such as “how,” “when,” and “where.” In another embodiment, analyzer 105 may identify questions using natural language processing analysis of the textual content found in the social media websites.

In step 302, analyzer 105 stores the questions found in the social media websites in database 106.

Once database 106 is populated with questions obtained from the social media websites, analyzer 105 may assist an expert (e.g., user of client device 101A) in answering preexisting questions, such as questions posted in various forums, without having the expert search for such questions to answer using the method of FIG. 4.

FIG. 4 is a flowchart of a method 400 for assisting an expert to answer preexisting questions in a time efficient manner using the questions populated in database 106 in accordance with an embodiment of the present invention.

Referring to FIG. 4, in conjunction with FIGS. 1-3, in step 401, analyzer 105 detects a data entry in data entry system 104, such as by an expert (e.g., user of client device 101A).

In step 402, analyzer 105 identifies the added or modified data in data entry system 104 in response to detecting the data entry in data entry system 104. In one embodiment, analyzer 105 identifies the added or modified data that was inputted by the expert in data entry system 104 in response to the expert saving or committing the changes.

In step 403, analyzer 105 searches database 106 containing questions obtained from social media websites to identify questions that could possibly be answered using the identified added or modified data. In one embodiment, questions in database 106 that could possibly be answered using the identified added or modified data are identified by tag searching using the content or structure from the data entry. Tag searching refers to searching for tags that correspond to a non-hierarchical keyword or term assigned to a piece of information. For example, blog systems may allow authors to add free-form tags to a post, along with (or instead of) placing the post into categories. For instance, a post may display that it has been tagged with baseball and tickets. Hence, if the expert's data entry includes content directed to baseball and/or tickets, then such a post may be identified.

In another embodiment, questions in database 106 that could possibly be answered using the identified added or modified data are identified by keyword searching using the content or structure from the data entry. For example, if the expert's data entry included the keywords of “relational” and “database,” then questions pertaining to a relational database may be identified.

In a further embodiment, questions in database 106 that could possibly be answered using the identified added or modified data are identified by natural language processing using machine learning of the content or structure from the data entry. For example, a meaning may be derived from the content, such as a user-entered description, pertaining to an event. For instance, suppose that the expert entered data pertaining to bats used in baseball. The term “bat” may be interpreted as corresponding to a flying mammal or to a wooden instrument for hitting a baseball. Since the term “baseball” was used in connection with the term “bat,” it may be deduced that the term “bat” refers to the wooden instrument used for hitting a baseball as opposed to a flying mammal. Such processing may be used to identify appropriate questions in database 106.

In step 404, analyzer 105 performs analytical analysis (e.g., statistical and/or logical techniques) on the identified questions (questions identified in step 403) to assign a relevance factor to assess how relevant is the expert's data entry in answering the question. For example, the analytical analysis may involve determining how relevant the expert's data entry (i.e., the identified added or modified data) is to a question based on several factors, such as the significance of the matching terms or concepts and the number of matching terms. The greater the number of matching terms or concepts as well as the greater the significance in those matching terms or concepts, the greater the relevancy.

In step 405, analyzer 105 assigns a relevance factor to each of the questions that could possibly be answered using the identified added or modified data.

In step 406, analyzer 105 identifies those questions whose relevance factor exceeds a threshold.

In step 407, analyzer 105 presents a list of those questions whose relevance factor exceeds a threshold (those questions identified in step 406) to the expert (e.g., user of client device 101A).

In step 408, a determination is made by analyzer 105 as to whether it receives a selection of a question presented in the list from the expert. For example, the expert may have entered changes in the documentation for operating systems for a particular type of relational database system. As a result, analyzer 105 may search and identify questions pertaining to operating systems for that particular type of relational database system in database 106. For those identified questions whose relevance factor exceeds a threshold, those questions would be presented in a list to the expert. If the expert believes that the inputted data (e.g., the data inputted by the expert concerning the operating systems for the relational database system) is pertinent to the question, then the expert selects that question from the list. In this manner, the expert does not have to spend time searching social media websites for applicable questions to answer. Instead, the expert may simply select the questions to answer by selecting those applicable questions from the list.

If analyzer 105 does not receive a selection of a question presented in the list from the expert, then analyzer 105 continues to determine if it received a selection of a question presented in the list from the expert in step 408.

If, however, analyzer 105 received a section of question(s) presented in the list from the expert, then, in step 409, analyzer 105 performs an action to provide an answer to the selected question(s) based on the identified added or modified data. For example, if the expert's inputted data was saved at a particular Uniform Resource Locator (URL), then analyzer 105 may post a link to that URL. In another example, analyzer 105 may e-mail the answer (i.e., the identified added or modified data) to the user who posted that question. In a further example, analyzer 105 may annotate and/or mark the question on the social media website (e.g., forum) with the answer for those users interested in the answer to that question. By having analyzer 105 perform such actions to provide an answer to the expert's selected question(s), the selected question(s) are answered in a time efficient manner without the expert spending a significant time in answering those questions.

An alternative method for assisting an expert to answer preexisting questions in a time efficient manner is discussed below in connection with FIG. 5.

FIG. 5 is a flowchart of a method 500 for assisting an expert to answer preexisting questions in a time efficient manner by seeking out questions in social media websites based on the input provided by the expert into data entry system 104 (FIG. 1) as discussed below in connection with FIG. 5.

Referring to FIG. 5, in conjunction with FIGS. 1-2, in step 501, analyzer 105 detects a data entry in data entry system 104, such as by an expert (e.g., user of client device 101A).

In step 502, analyzer 105 identifies the added or modified data in data entry system 104 in response to detecting the data entry in data entry system 104. In one embodiment, analyzer 105 identifies the added or modified data that was inputted by the expert in data entry system 104 in response to the expert saving or committing the changes.

In step 503, analyzer 105 searches social media websites (e.g., blogs, forums, communities) to identify questions that could possibly be answered using the identified added or modified data. In one embodiment, such questions are stored in database 106. In one embodiment, questions in social media websites that could possibly be answered using the identified added or modified data are identified by tag searching using the content or structure from the data entry. As discussed above, tag searching refers to searching for tags that correspond to a non-hierarchical keyword or term assigned to a piece of information. For example, blog systems may allow authors to add free-form tags to a post, along with (or instead of) placing the post into categories. For example, a post may display that it has been tagged with baseball and tickets. Hence, if the expert's data entry includes content directed to baseball and/or tickets, then such a post may be identified.

In another embodiment, questions in social media websites that could possibly be answered using the identified added or modified data are identified by keyword searching using the content or structure from the data entry. For example, if the expert's data entry included the keywords of “relational” and “database,” then questions pertaining to a relational database may be identified.

In a further embodiment, questions in social media websites that could possibly be answered using the identified added or modified data are identified by natural language processing using machine learning of the content or structure from the data entry. For example, a meaning may be derived from the content, such as a user-entered description, pertaining to an event. For instance, suppose that the expert entered data pertaining to bats used in baseball. The term “bat” may be interpreted as corresponding to a flying mammal or to a wooden instrument for hitting a baseball. Since the term “baseball” was used in connection with the term “bat,” it may be deduced that the term “bat” refers to the wooden instrument used for hitting a baseball as opposed to a flying mammal. Such processing may be used to identify appropriate questions in the social media websites.

In step 504, analyzer 105 performs analytical analysis (e.g., statistical and/or logical techniques) on the identified questions (questions identified in step 503) to assign a relevance factor to assess how relevant is the expert's data entry in answering the question. For example, as discussed above, the analytical analysis may involve determining how relevant the expert's data entry (i.e., the identified added or modified data) is to a question based on several factors, such as the significance of the matching terms or concepts and the number of matching terms. The greater the number of matching terms or concepts as well as the greater the significance in those matching terms or concepts, the greater the relevancy.

In step 505, analyzer 105 assigns a relevance factor to each of the questions that could possibly be answered using the identified added or modified data.

In step 506, analyzer 105 identifies those questions whose relevance factor exceeds a threshold.

In step 507, analyzer 105 presents a list of those questions whose relevance factor exceeds a threshold (those questions identified in step 506) to the expert (e.g., user of client device 101A).

In step 508, a determination is made by analyzer 105 as to whether it receives a selection of a question presented in the list from the expert. For example, as discussed above, the expert may have entered changes in the documentation for operating systems for a particular type of relational database system. As a result, analyzer 105 may search and identify questions pertaining to operating systems for that particular type of relational database system in database 106. For those identified questions whose relevance factor exceeds a threshold, those questions would be presented in a list to the expert. If the expert believes that the inputted data (e.g., the data inputted by the expert concerning the operating systems for the relational database system) is pertinent to the question, then the expert selects that question from the list. In this manner, the expert does not have to spend time searching social media websites for applicable questions to answer. Instead, the expert may simply select the questions to answer by selecting those applicable questions from the list.

If analyzer 105 does not receive a selection of a question presented in the list from the expert, then analyzer 105 continues to determine if it received a selection of a question presented in the list from the expert in step 508.

If, however, analyzer 105 received a section of question(s) presented in the list from the expert, then, in step 509, analyzer 105 performs an action to provide an answer to the selected question(s) based on the identified added or modified data. For example, as discussed above, if the expert's inputted data was saved at a particular Uniform Resource Locator (URL), then analyzer 105 may post a link to that URL. In another example, analyzer 105 may e-mail the answer (i.e., the identified added or modified data) to the user who posted that question. In a further example, analyzer 105 may annotate and/or mark the question on the social media website (e.g., forum) with the answer for those users interested in the answer to that question. By having analyzer 105 perform such actions to provide an answer to the expert's selected question(s), the selected question(s) are answered in a time efficient manner without the expert spending a significant time in answering those questions.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for assisting an expert to answer preexisting questions in a time efficient manner, the method comprising:
detecting a data entry in a data entry system;
identifying added or modified data in said data entry system in response to detecting said data entry in said data entry system;
searching, by a processor, a database or social media websites to identify questions that could possibly be answered using said identified added or modified data;
assigning a relevance factor to each of said questions that could possibly be answered using said identified added or modified data;
identifying questions whose relevance factor exceeds a threshold;
presenting a list of said identified questions whose relevance factor exceeds said threshold to said expert;
receiving a selection of one or more questions presented in said list of said identified questions; and
performing an action to provide an answer to said selected one or more questions using said identified added or modified data.

2. The method as recited in claim 1 further comprising:
searching said social media websites to populate said database with questions; and
saving said questions found in said social media websites in said database.

3. The method as recited in claim 1 further comprising:
performing one or more of the following to identify questions that could possibly be answered using said identified added or modified data: tag searching using content from said data entry; keyword searching using said content from said data entry; and natural language processing of said content from said data entry.

4. The method as recited in claim 1 further comprising:
performing analytical analysis on said identified questions that could possibly be answered using said identified added or modified data in order to assign said relevance factor to each of said questions that could possibly be answered using said identified added or modified data.

5. The method as recited in claim 1, wherein said action comprises one or more of the following: posting, e-mailing, annotating and marking.

6. The method as recited in claim 1, wherein said data entry system is one of the following types of systems: expert, official and trusted.

7. The method as recited in claim 1, wherein said social media websites comprise one or more of the following: blogs, forums and communities.

8. A computer program product embodied in a computer readable storage medium for assisting an expert to answer preexisting questions in a time efficient manner, the computer program product comprising the programming instructions for:
detecting a data entry in a data entry system;
identifying added or modified data in said data entry system in response to detecting said data entry in said data entry system;
searching a database or social media websites to identify questions that could possibly be answered using said identified added or modified data;
assigning a relevance factor to each of said questions that could possibly be answered using said identified added or modified data;
identifying questions whose relevance factor exceeds a threshold;
presenting a list of said identified questions whose relevance factor exceeds said threshold to said expert;
receiving a selection of one or more questions presented in said list of said identified questions; and
performing an action to provide an answer to said selected one or more questions using said identified added or modified data.

9. The computer program product as recited in claim 8 further comprising the programming instructions for:
searching said social media websites to populate said database with questions; and
saving said questions found in said social media websites in said database.

10. The computer program product as recited in claim 8 further comprising the programming instructions for:
performing one or more of the following to identify questions that could possibly be answered using said identified added or modified data: tag searching using content from said data entry; keyword searching using said content from said data entry; and natural language processing of said content from said data entry.

11. The computer program product as recited in claim 8 further comprising the programming instructions for:
performing analytical analysis on said identified questions that could possibly be answered using said identified added or modified data in order to assign said relevance factor to each of said questions that could possibly be answered using said identified added or modified data.

12. The computer program product as recited in claim 8, wherein said action comprises one or more of the following: posting, e-mailing, annotating and marking.

13. The computer program product as recited in claim 8, wherein said data entry system is one of the following types of systems: expert, official and trusted.

14. The computer program product as recited in claim 8, wherein said social media websites comprise one or more of the following: blogs, forums and communities.

15. A system, comprising:
a memory unit for storing a computer program for assisting an expert to answer preexisting questions in a time efficient manner; and
a processor coupled to said memory unit, wherein said processor, responsive to said computer program, comprises:
circuitry for detecting a data entry in a data entry system;
circuitry for identifying added or modified data in said data entry system in response to detecting said data entry in said data entry system;
circuitry for searching a database or social media websites to identify questions that could possibly be answered using said identified added or modified data;
circuitry for assigning a relevance factor to each of said questions that could possibly be answered using said identified added or modified data;
circuitry for identifying questions whose relevance factor exceeds a threshold;
circuitry for presenting a list of said identified questions whose relevance factor exceeds said threshold to said expert;
circuitry for receiving a selection of one or more questions presented in said list of said identified questions; and
circuitry for performing an action to provide an answer to said selected one or more questions using said identified added or modified data.

16. The system as recited in claim 15, wherein said processor further comprises:
circuitry for searching said social media websites to populate said database with questions; and
circuitry for saving said questions found in said social media websites in said database.

17. The system as recited in claim 15, wherein said processor further comprises:
circuitry for performing one or more of the following to identify questions that could possibly be answered using said identified added or modified data: tag searching using content from said data entry; keyword searching using said content from said data entry; and natural language processing of said content from said data entry.

18. The system as recited in claim 15, wherein said processor further comprises:
circuitry for performing analytical analysis on said identified questions that could possibly be answered using said identified added or modified data in order to assign said relevance factor to each of said questions that could possibly be answered using said identified added or modified data.

19. The system as recited in claim 15, wherein said action comprises one or more of the following: posting, e-mailing, annotating and marking.

20. The system as recited in claim 15, wherein said social media websites comprise one or more of the following: blogs, forums and communities.
